(19) United States
(12) Patent Application Publication
(10) Pub. No.: US 2007/0239839 A1
(43) Pub. Date: Oct. 11, 2007

(54) Method for multimedia review synchronization

(76) Inventors: Michael Ernest Buday, Dana Point, CA (US); Lance Edward Kelson, Alpharetta, GA (US); Ramsey Adly Marzouk, Round Lake, IL (US); Alexander Asenov Lefterov, Sofia (BG)

Correspondence Address: STETINA BRUNDA GARRED & BRUCKER, 75 ENTERPRISE, SUITE 250, ALISO VIEJO, CA, 92656, US

(21) Appl. No.: 11/399,279

(22) Filed: Apr. 6, 2006

(51) Int. Cl. G06F 15/16

(52) U.S. Cl. 709/208

(57) ABSTRACT

Disclosed is a method of synchronizing media review on first and second nodes. The method may include the step of loading a media file having sequenced data segments into the first and second nodes. The media review may be related to processing the data segments for output. The method may also include the step of establishing a synchronized communication session between the first node and the second node. Thereafter, the method may include the step of executing a local media review command, and transmitting a remote media review command derived therefrom. The local and remote media review commands may be operative to regulate the media review of the media file on the first and second nodes.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates generally to methods for synchronous control over networked nodes, and more particularly, to methods for collaboratively reviewing multimedia works by users in remote locations.

2. Related Art

Developing video and film works involve numerous interrelated stages, including development, pre-production, production, post-production, and so forth. The initial development stage typically involves the creation of a script, followed by set construction, casting and other preparatory activities during the pre-production stage. During production, particularly during principal photography, the footage that will eventually make up the final video or film is captured. This is followed by the post-production stage, in which all of the footage taken during principle photography is sequenced according to the script and a producer's interpretation of the same.

Current video and film editing techniques evolved from traditional film editing methods of cutting and splicing individual pieces of film. Film was typically edited in non-linear style, where new shots could be inserted between frames of another shot. However, video editing was typically linear, in which desired portions of a source tape were played back and copied to an edit master tape. This was because splicing the magnetic tape was extremely cumbersome, with substantial likelihood of degradation and error.

Rapid increases in processing power and storage capacities of digital computer systems have enabled video and film editing to be performed on such systems. More particularly, footage captured by the camera, which may be stored in analog or digital form, is transferred to the computer and edited with a non-linear editing software application such as AVID MEDIA COMPOSER and APPLE FINAL CUT PRO. Analog footage is converted to digital data comprising a sequence of individually accessible frames, with each of the frames being representative of the footage at any single point in time. Each of the frames typically included time code or frame number information, which facilitates individual frame accession. Because digital footage is already in the necessary format, no conversion is necessary.

As will be appreciated by a skilled artisan, video and film production requires collaboration amongst numerous individuals, including such key production personnel as producers, directors and editors. During the editing stage, it was frequently the case for the professionals to convene at one location to discuss details related to an ongoing work. There may be one computer system that has the work loaded and being displayed thereon, with all of the participants having a common reference by which further discussion may proceed. For example, when a particular frame is displayed, all of the participants are able to view that frame, comment thereupon and suggest modifications. It will also be appreciated, however, that every one of the key production personnel may be in different locations all over the world, making it impossible to physically convene for editing discussions as mentioned above.

With significant advances in high speed data communications, it has become possible for editors, directors and producers to remain in contact with each other and discuss daily updates relating to the progress of the final work. These so-called “dailies,” or rough edits of the final work, may be saved to a media file and uploaded to a storage site on the internet. Thereafter, the producer, director and others may download the media file for local viewing and discussing the edits. The media file was typically played back on a media player application program such as QUICKTIME, WINDOWS MEDIA PLAYER or the like. The media file contained each of the frames associated with the work, and was sequentially displayed according to a specified rate on a monitor. Audio information sequenced to the individual frames was output to an acoustic transducer device.

A conference between these individuals may then be initiated over telephone or over any of the well known internet conferencing systems such as SKYPE, instant messaging and so forth. During the conference, the editors, directors and producers were able to comment on the work and offer suggestions as though the participants were in the same room, just as before, but there were a number of deficiencies. Particularly, the participants were unable to rapidly determine which segment of the file was under current consideration without significant overhead conversation to designate the particular location within the file. Furthermore, once playback was started or jumped to a different frame, the participant initiating such action needed to properly communicate this fact to the other participants. This led to confusion during the review process, and wasted a significant amount of time. Therefore, a method which would overcome such deficiencies would be desirable in the art.

### BRIEF SUMMARY

In order to overcome the above deficiencies and more, according to an aspect of the present invention, there is provided a method of synchronizing media review on first and second nodes. The method may include a step of loading a primary media file having a plurality of sequenced data segments into the first and second nodes. The media review may be related to processing of the data segments of the primary media file for output. The method may also include a step of establishing a synchronized communication session between the first node and the second node with a first protocol. The method may further include the step of executing a local media review command on the first node. The local media review command may include instructions operative to regulate the media review on the first node. Additionally, the method may include the step of transmitting from the first node to the second node a remote media review command derived from the local media review command. The remote media review command may include instructions operative to regulate the media review of the primary media file on the second node.

In accordance with one embodiment of the present invention, the method may include a step of selectively enabling execution of the instructions of the local media review command on the first node. The selective enabling step may be in response to identification of the first node as a primary node. Further, the method may include the step of selectively disabling execution of the instructions of the remote media review command on the second node. The selective disabling step may be in response to identification of the first node as a secondary node. The identification of the first node as the secondary node may include the step of transmitting a primary status relinquishment command from the first node to the second node.

In yet another aspect of the present invention, after establishing the synchronized communication session, there is provided a step of streaming a secondary media file from the storage server to the second node. The step of establishing the synchronized communication session may include transmitting a session synchronization signal from the first node to the second node. The session synchronization signal may include a sequence value specifying the respective one of the data segments of the media file on the first and second nodes. The session synchronization signal may also be operative to initiate the media review of the media file from the data segment specified by the sequence. Furthermore, the step of establishing the synchronized communication session may be initiated through a teleconferencing protocol different from the first protocol.

In another embodiment of the present invention, at least one of the data segments of the primary media file may include a reserved area for storing an annotation. Alternatively, at least one of the data segments may include a pointer referencing an annotation and an identifier for random access to the one of the data segments. In one embodiment, the annotation may include text data. In another embodiment, the annotation may include graphical data. The method may also include the step of exporting to a record the annotation referenced by the pointer associated with the respective one of the data segments of the primary media file. In this regard, the record may include the identifier. The identifier may be a time code value associated with the one of the data segments of the primary media file, or a frame count value of the one of the data segments of the primary media file.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram of a network of computer systems according to an aspect of the present invention;

FIG. 2 is a block diagram of a data processing device in accordance with one aspect of the present invention;

FIG. 3 illustrates a graphical user interface of a media player computer application program for displaying, controlling, and/or otherwise processing media files;

FIG. 4 depicts a series of frames of a media file with the relevant elements thereof;

FIG. 5 is a diagram illustrating the data structure of a tag for storing metadata, including specific elements that define the tag;

FIG. 6 is a diagram of a network of a first node and a second node connected to each other via the Internet;

FIG. 7 is a flowchart describing the methodology according to one aspect of the present invention;

FIG. 8a is a block diagram illustrating three nodes, with one of the nodes designated as a primary node and the other nodes being designated as secondary nodes;

FIG. 8b is a block diagram illustrating three nodes, with a different node being designated as a primary node as compared to FIG. 8a;

FIG. 8c is a block diagram illustrating three nodes in which two of the nodes are designated as primary nodes;

FIG. 9 is a sequence diagram depicting the messages transmitted for synchronizing media review between a first node and a second node in accordance with an aspect of the present invention; and

FIG. 10 is a sequence diagram depicting the messages transmitted for propagating locators.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second, and the like are used solely to distinguish one from another entity without necessarily requiring or implying any actual such relationship or order between such entities.

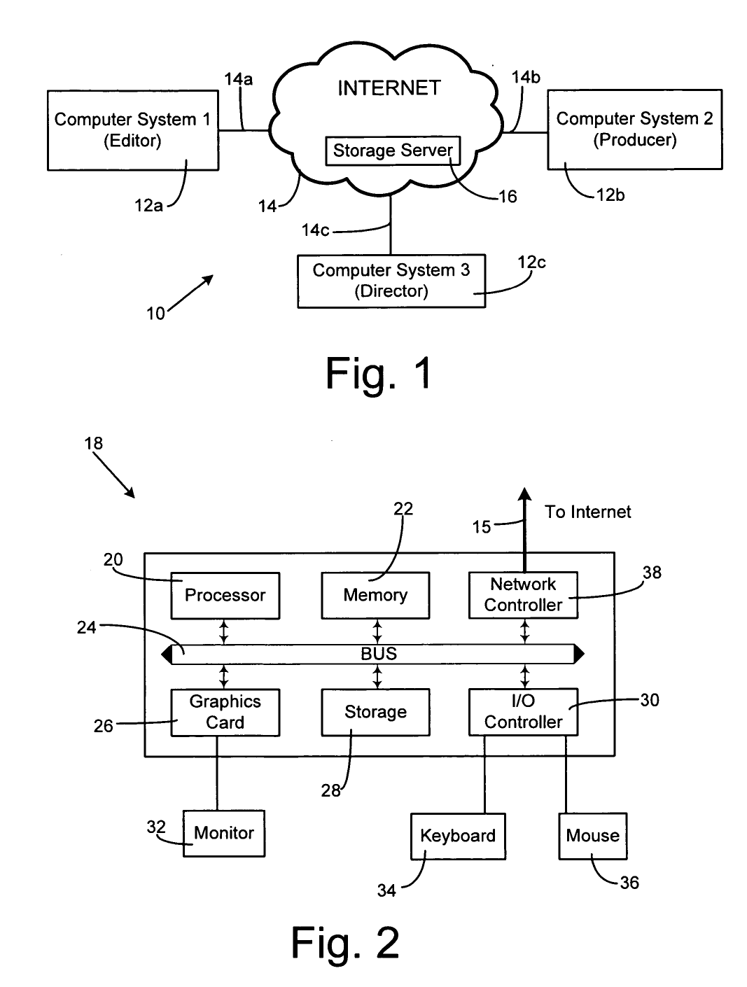

With reference to FIG. 1, there is a diagram of a network of computer systems in which time based media data representative of movies, video, music, animation and so forth may be processed, according to one embodiment of the present invention. A network 10 includes a number of computer systems or nodes 12a, 12b, and 12c, hereinafter collectively referred to as computer systems 12. It will be appreciated the term “node” is readily interchangeable with the term “computer system,” and for certain examples set forth below, one usage may be selected over another for giving context to the particular example. For purposes of example only and not of limitation the computer system 12a is in use by an editor, and further occurrences thereof will be referenced as the editor computer system 12a. Likewise, computer system 12b is in use by a producer, and so will be referenced as the producer computer system 12b. Finally, computer system 12c is in use by a director, and so will be referenced as the director computer system 12c.

It will be appreciated that other professionals may be connected to each other by the network, such as a co-producer or a co-director and the like. Each of the computer systems 12 are coupled together through an Internet 14 via Internet links 14a, 14b, and 14c. It will be understood by one of ordinary skill in the art that the Internet 14 refers to a network of networks. Such networks may use a variety of well known protocols for data exchange, such as TCP/IP, ATM and so forth. It will also be understood that the computer systems 12 may all be located in the same room, in the same building but in different rooms, or in different countries. Thus, the Internet 14 may be readily substituted with any suitable networking methodology, including LANs, etc. Additionally, there may be a storage server 16 connected to the Internet 14 which is accessible by all of the computer systems 12. In this regard, access to data is ensured in case one of the computer systems 12 disconnect from the Internet 14. Further, in many instances, the network connections 14a, 14b, and 14c are asymmetrical, meaning that outgoing traffic and incoming traffic are not being transferred at the same rate. Rather, in typical configurations the outgoing speed is considerably lower than the incoming speed, thereby increasing the time in which a given file is transferred from one of the computer systems 12 to another. The storage server 16 may be utilized as an FTP server where an entire file is transferred at once prior to processing, but may also be a streaming server where chunks of data in the file are processed as transmission occurs.

Referring now to FIG. 2, a block diagram illustrates an exemplary data processing system 18. It will be appreciated that the data processing system 18 may be used as one of the computer systems 12, the storage server 16, or any other like device which is connected to the Internet 14. The data processing system 18 includes a central processor 20, which may represent one or more conventional types of such processors, such as an IBM PowerPC processor, an Intel Pentium (or ×86) processor and so forth. A memory 22 is coupled to the central processor 20 via a bus 24. The memory 22 may be a dynamic random access memory (DRAM) and/or include static RAM (SRAM), and serves as a temporary data storage area. The bus 24 further couples the central processor 20 to a graphics card 26, a storage unit 28 and an input/output (I/O) controller 30. The storage unit 28 may be a magnetic, optical, magneto-optical, tape or other type of machine-readable medium or device for storing data, such as CD-ROM drives, hard drives and the like. The graphics card 26 transmits signals representative of display data to a monitor 32, which may be a Cathode Ray Tube (CRT) monitor, a Liquid Crystal Display (LCD) monitor or other suitable display device. The I/O controller 30 receives input from various devices such as a keyboard 34 or a mouse 36, but may also transmit output to printers, speakers, etc. Essentially, the I/O controller 30 converts signals from the peripheral devices such that signals therefrom may be properly interpreted by the central processor 20, and also converts signals from the central processor 20 to the peripherals.

The data processing system 18 includes a network controller 38, which is also coupled to the central processor 20 via the bus 24. As will be recognized by one of ordinary skill in the art, at the physical level, the network controller 38 includes electronic circuitry to transmit signals representative of data from one location to another. Applicable standards utilized at this level include 100Base-T, Gigabit Ethernet and Coax. In many cases, physical wires form an exemplary data link 15, but in many other cases the data link 15 may be wireless, such as those in links conforming to the Institute of Electrical and Electronics Engineers (IEEE) 802.11 standard. Further, the individual signals may form a part of an Internet Protocol (UP) packet, and organized according to the Transportation Control Protocol (TCP). It will further be recognized that any suitable networking may be readily substituted without departing from the scope of the present invention. For example, a modem over a telephone line may be substituted for the network controller 38 and data link 15, respectively.

A typical data processing system 18 includes an operating system for managing other software applications, as well as the various hardware components. Among the most common operating systems include MICROSOFT WINDOWS, APPLE MACOS, UNIX and so forth. Generally, the operating system and other software applications are tangibly embodied in a computer-readable medium, e.g. one or more of the fixed and/or removable data storage devices 28. Both the operating system and the other software applications may be loaded from the data storage device 28 into the memory 22 for execution by the central processor 20, and comprise instructions which, when read and executed by the central processor 20, causes the data processing system 18 to perform the steps necessary to execute the steps or features of the present invention.

It will be appreciated that the data processing system 18 represents only one example of a device, which may have many different configurations and architectures, and which may be employed with the present invention. For example, the storage server typically will not include a graphics card 26 or a monitor 32 because during production use of visual outputs is not necessary. Additionally, a portable communication and processing system, which may employ a cellular telephone, paging and/or e-mail capabilities, may be considered a data processing system 18.

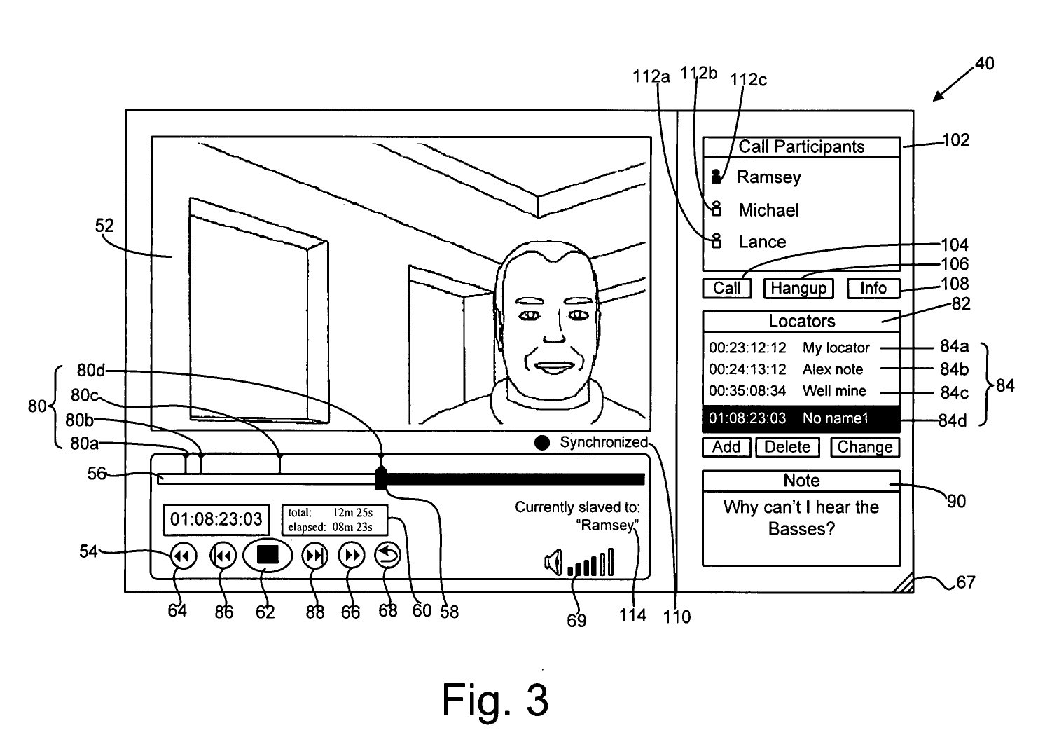

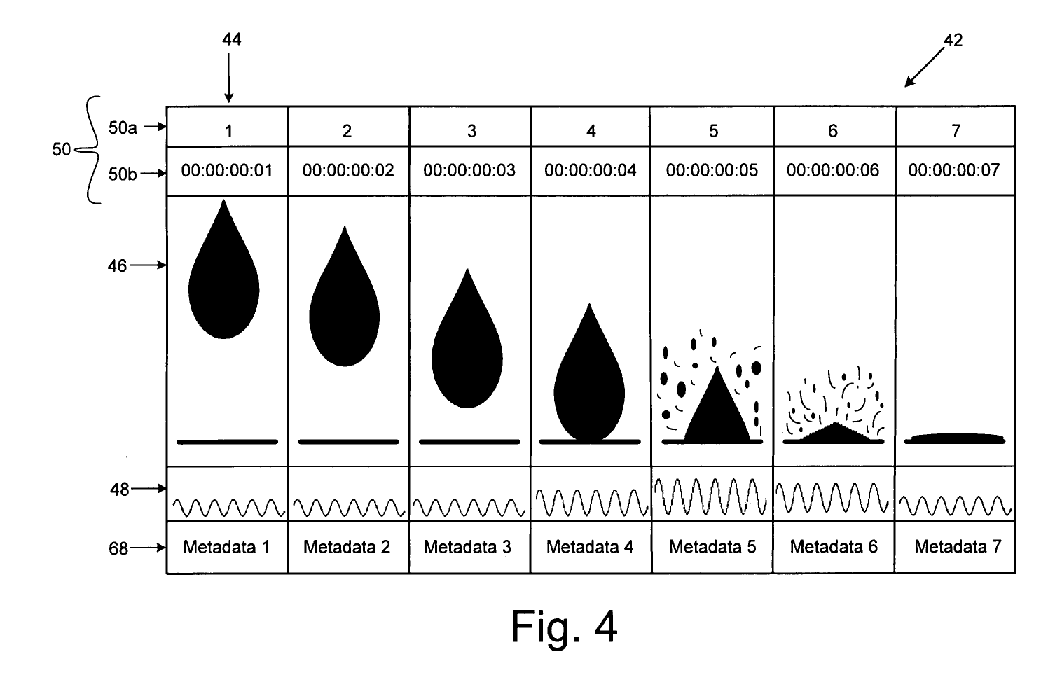

With reference now to FIG. 3, a graphical user interface (GUI) of a software application operative to process and display media files on a data processing system is shown. As will be understood, such a software application is known in the art as a media player 40. Referring to FIG. 4, conceptually, a media file 42 represents digital video as a sequence of individual frames 44. More particularly, the frames 44 include a video portion 46 and an audio portion 48. The frames 44 are segregated by an index 50, which may be representative of a frame-count value 50a or a time-code value 50b. Any particular frame rate may be utilized, meaning the number of frames per a given interval of time, such as 24 frames per second. In the particular media file 42 illustrated in FIG. 4, the time code format is utilized, with a one frame per millisecond frame rate. In a digital file, the individual pixels of each frame are encoded, placed in a particular location of memory and indexed by the aforementioned index 50. A variety of encoding methods which compress the individual frames or intelligently remove certain frames from the media file 42 may be utilized, as embodied in a codec. Amongst the popular codecs include Moving Picture Experts Group-1 (MPEG-1), MPEG-2, and WINDOWS MEDIA VIDEO (WMV). Any number of container formats such as Audio Video Interleave (AVI), MOV, etc. may be utilized. As understood, the container formats specify the layout in which all of the elements of the media file 42, including the video portion 46, the audio portion 48 and the index 50 are encapsulated into one file. It will be understood by one of ordinary skill in the art that the media player 40 includes instructions which sequentially load the individual frames from the media file 42, and displays the same at a particular rate specified. This function is known as “playing back” the media file 42. A function of the media player 40 which enables the random access of the particular memory location or frame is referred to as a play head. A particular a play head as implemented in the media player 40 will be discussed in further detail below.

Referring again to FIG. 3, the media player 40 includes a video pane 52, in which the video and other information contained within the media file 42 are displayed. In addition, a time/file display 54 and a scrub area 56 provide functionality for displaying and/or controlling time associated with a particular media file 42. The scrub area 56 is representative of the frames 44 of the media file 42, and a play head 58 indicates the current frame being displayed. As the media file 42 is played back, the play head 58 progresses from left to right, with the area to the left of the play head 58 on the scrub area 56 representative of the frames 44 already played back, and the area to the right of the play head 58 on the scrub area 56 representative of the remaining frames 44. It will be appreciated that the play head 58 can be positioned and re-positioned anywhere along the scrub area 56, allowing for random access, and the time/file display 54 is updated upon positioning. When referring to the play head 58, it will also be understood to encompass the concept of the play head as discussed above, specifically the functional feature of the media player 40 that enables random access to a memory location or frame. Accordingly, when referring to “repositioning the play head 58,” it will be understood that the visual location of the play head 58 within the scrub area 56 is adjusted, as well as accessing a different frame or location within the media file 42 and initiating the processing of that frame. A person of ordinary skill in the art will recognize that any input involving “repositioning the play head 58” is also known as “scrubbing.” As further indication of the amount of time elapsed, a timer display 60 may output the total amount of time the media file 42 will run, and the amount of time which has elapsed. It is understood that any number and combination of time indicators may be included without departing from the scope of the present invention.

The media player 40 includes a number of other mechanisms for controlling the processing of the media file 42. A play/stop button 62 is operative to instruct the media player 40 to begin playing back the media file 42 at the standard speed from the position indicated by the play head 58 and the time/file display 54. By way of example only and not of limitation, the play/stop button 62 is a single button that has multiple states. For instance, when the media player 40 has stopped at a given location, then the play/stop button 62 displays the well recognized rotated triangle symbol to depict “play.” When the media player 40 is currently playing back the media file 42, the play/stop button 62 displays the also well recognized square symbol to depict “stop.” A rewind button 64 is operative to instruct the play head 58 to sequentially traverse the media file 42 in reverse order, while a fast forward button 66 increases the playback speed. There is also provided a reset button 68, which is operative to re-position the play head 58 back to the beginning of the media file 42 and reinitiate the playing back of the same. Collectively, these mechanisms will be referred to herein as playback controls, and are activated by navigating a cursor to the respective buttons, and “clicked” using a mouse button. Further, the actions taken in response to inputs from the playback controls will generally be understood to mean the playback of the media file 42, including such actions as fast forwarding, rewinding, stopping, playing back and so forth. It is important that the term “playing back” is distinguished from the term “playback,” for “playing back” has a more limited meaning, referring to the sequential processing of the media file 42 at a specified speed, while the term “playback” refers generally to the processing of the media file 42, whether fast forwarding, stopping, rewinding or other functionality. It will be understood that the term “playback” is not limited to the functionality associated with the processing of the media file 42 as described above, and may include additional functionalities.

Unrelated to the functionality provided by the playback controls, the GUI of the media player 40 also includes a volume adjustment icon 69 which controls the audio output level (e.g., through speakers, headphones, or other audio output device.) In the embodiment as illustrated in FIG. 3, various output levels are represented by successively enlarging bars. The cursor may be clicked on the volume adjustment icon 69 and dragged from left to right, in which dragging to the left results in a lower output level and dragging to the right results in a higher output level. It will be recognized by one of ordinary skill in the art, however, that any suitable volume adjustment interface may be utilized.

As any conventional GUI will permit, the media player 40 may be minimized, maximized, and resized on a display. Particularly, the size of the media player 40 and the various subsections thereof referred to herein as panes may be varied by activating a resize control 67. The resize control 67 may be dragged towards the corner of the media player 40 opposite that of the resize control 67 to reduce its size, and in the opposite direction to increase its size. It will be understood that reductions in size are limited to that which will not hide or otherwise distort the appearance of the various elements on the media player 40, which will be discussed in further detail below. Adjustments made through the resize control 67 will result in proportional increases in size of the respective panes constituting the media player 40. Additionally, the aspect ratio, or the length and height relationship of the video pane 52, will be maintained while resizing.

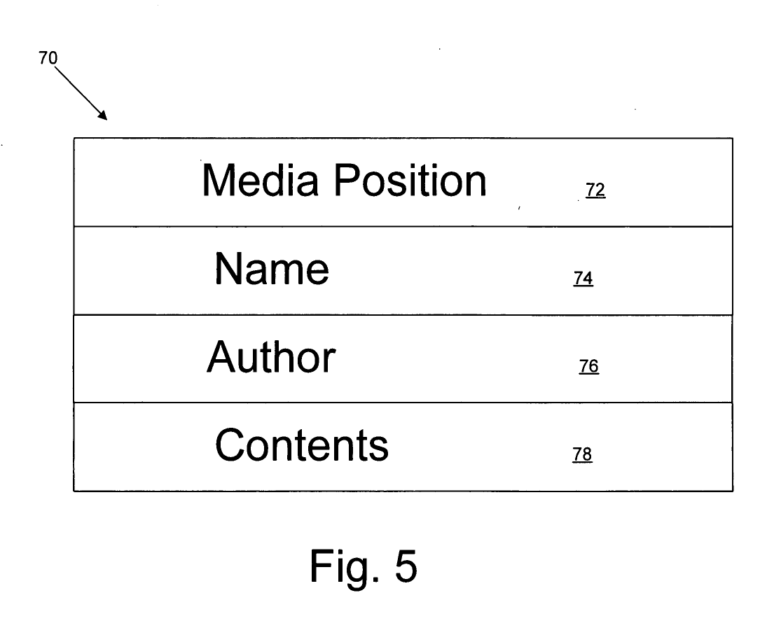

According to another aspect of the present invention, it is possible to add a plurality of metadata to individual frames of the media file 42. With reference to FIGS. 3-5, each of the frames 44 include a tag reference 68, which points to a location in the memory 22 in which a tag 70 is located. It is also contemplated that the tag reference 68 includes references to multiple tags. As shown in the data structure diagram of FIG. 5, the tag 70 includes a media position element 72, a name element 74, an author element 76 and a contents element 78. The media position element 72 is a reference to the particular frame 44 which references the tag 70 with the tag reference 68. Thus, it will be appreciated that the metadata may be indexed by time code or frame count. The name element 74 provides a brief description for the tag 70, and the author element 76 identifies the creator of the tag 70. Additionally, contents element 78 holds the relevant data of the tag 70, which can include plaintext, binary data files such as Joint Photographic Expert Group (.JPG) image files, word processing documents, Portable Document Format (PDF) files, and the like, HyperText Markup Language/eXtensible Markup Language (HTML/XML) data, Vertical Blanking Interval (VBI) data, Global Positioning System (GPS) data, and so forth. Additionally, manipulations to the particular frame 44 may also be stored in the contents element 78, such as pan and scan information, zoom information, color adjustments and graphical or video overlay data displayed above the video portion 46 of the frame 44. Such graphical overlay data may be in the form of annotations such as lines, shapes, drawn text, etc.

With regard to the storage location of the tag 70, all of the elements of the same may be encapsulated as a single data block within what would otherwise be the media position element 72, instead of the utilizing reference pointers as discussed above. Accordingly, any additional information held with the tag 70 will be stored in the media file 42. Where this is not done, however, the tag 70 may be stored in a separate file, and be associated with the media file 42 as a master tag list. It will be understood that such a master tag list may be individually created by a user and can be exported as a text file in exchange formats such as XML, Open Media Framework (OMF), Advanced Authoring Format (AAF) or Edit Decision List (EDL). The sharing of these files and the metadata contained therein will be described in further detail below.

Instances of the tag 70 may also be represented on the GUI of the media player 40 as locators 80. By way of example only and not of limitation, particular instances of the tag 70 are represented as a first locator 80a, a second locator 80b, a third locator 80c and a fourth locator 80d. The locators 80 are displayed immediately above the scrub area 56, and positioned so as to be representative of the location within the media file 42 as specified by the media position element 72 of the respective tag 70. Additionally, in a locator pane 82 are a first entry 84a corresponding to the first locator 80a, a second entry 84b corresponding to the second locator 80b, a third entry 84c corresponding to the third locator 80c, and a fourth entry 84d corresponding to the fourth locator 80d, collectively referenced as entries 84. The entries 84 each include the value of the media position element 72 and the corresponding name element 74 associated with the particular tag 70 represented by the particular one of the entries 84. For example, the first locator 80a represents the tag 70 having a media position element 72 value of “00:23:12:12,” and the corresponding entry 84a displays that value, as well as the value of the name element 74, which is “My locator.” The entries 84 are sorted according to the value of the media location element 72.

Many ways exist for repositioning the play head 58. In order to jump to one of the locators 80 immediately, one of the entries 84 on the locator pane 82 corresponding to the desired one of the locators 80 may be selected by navigating the cursor thereto and clicking on the mouse button. This action repositions the play head 58 to the selected one of the locators 80. Furthermore, by using a previous locator button 86, the play head 58 is re-positioned to one of the locators 80 immediately behind the current position of the play head 58, and by using a next locator button 88, the play head 58 is advanced to one of the locators 80 immediately after the current position of the play head 58. When either one of the aforementioned actions are taken, one of the entries 84 corresponding to the locator 80 to which the play head 58 was moved is accentuated by reversing the background and the foreground color of the text, or any well know and well accepted method therefor. It may also be possible to drag the play head 58 to the exact location of one of the locators 80. The results are similar to that of repositioning the play head 58 using the entries 84, or the previous and next locator buttons 86 and 88, respectively.

The above-described controls for re-positioning the play head 58 with respect to the locators 80, including previous locator button 86 and next locator button 88, will be collectively referred to as locator navigation controls. Furthermore, those functions involved with re-positioning the play head 58 as related to the locators 80 are also referred to as locator navigation, as well as “scrubbing.” In general, locator navigation controls and playback controls will be referred to as media review controls, and the functions involved therewith are encompassed under the term “media review” or “media review functionality.” The commands which are representative of such functionality that signal the media player 40 to execute the same are referred to as “media review commands.” It will be understood by those of ordinary skill in the art, however, that additional functionality relating to the review of the media file 42 may also be encompassed within the broad term of “media review.”

Upon positioning the play head 58 to one of the locators 80, any textual data contained in the contents element 78 of the particular tag 70 represented thereby is displayed in a note panel 90. In the exemplary GUI of FIG. 3, because the contents element 78 of one instance of the tag 70 represented by the locator 80d contains the string: “Why can't I hear the basses?” that is what appears on the note panel 90. Additionally, if any graphics were overlaid at the particular frame 44 of the selected one of the locators 80, those graphics will appear on the video pane 52.

On the lower portion of the locator pane 82 are a series of buttons having functionality related to the locators 80. An add button 92 adds a new locator at the current position of the play head 58, while a delete button 94 removes a currently selected locator, eliminating it from the locator panel 82 and the scrub area 56. A change button 96 is operable to allow editing of the name element 84 as displayed through one of the selected entries 84 on the locator panel 82, or the editing of the contents element 78 as displayed through the note panel 90.

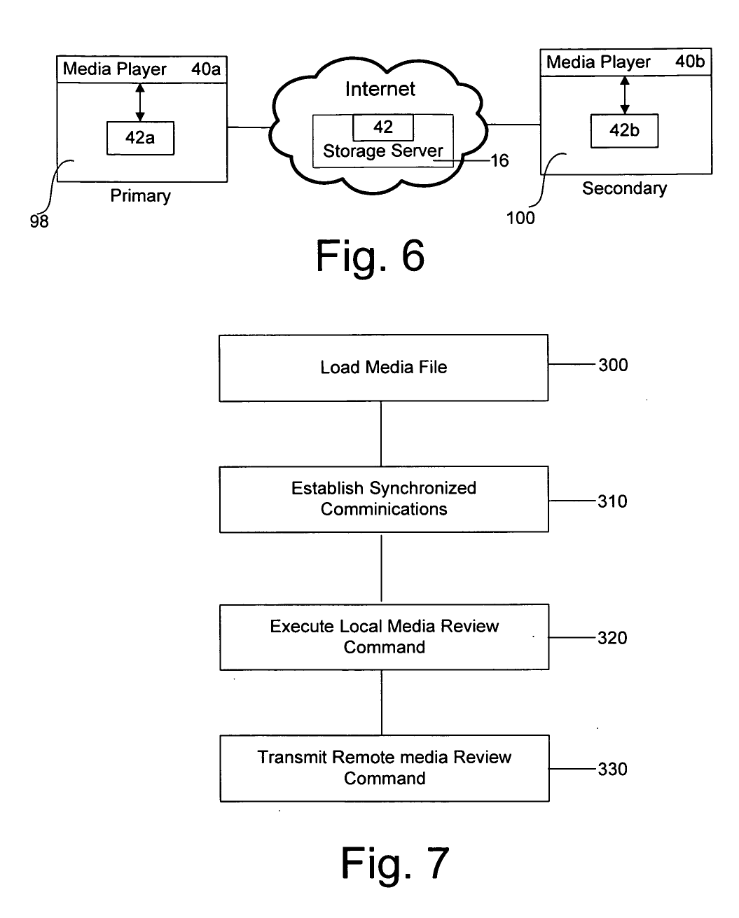

Having described the media review functionality of the media player 40 in the context of a single data processing system 18, the media review functionality as between instances of the media player 40 running on multiple data processing systems will now be described. In accordance with one aspect of the present invention, a method of synchronizing media review on one computer system to another computer system is provided. With reference now to FIG. 6 and the flowchart of FIG. 7, a first node 98 and a second node 100 are connected via the Internet 14. It will be understood that the first and second nodes 98, 100 are specific embodiments of the data processing system 18 of FIG. 2.

According to step 300, the method includes loading a first copy of the media file 42a on the first node 98, and loading a second copy of the media file 42b on the second node 100. The first copy of the media file 42a is handled by a first instance of the media player 40a, and the second copy of the media file 42b is handled by a second instance of the media player 40b. It is typically the case that a number of different media files for different scenes and different projects will be available for loading. In this regard, there is a possibility that different media files will have the same file name, and so a checksum is created of all media files to uniquely identify the same. Amongst the well known checksum generating means include the MD5 hashing algorithm. Due to the fact that large media files are often handled by the media player 40, the MD5 hashing is performed only to the limited extent of uniquely identifying the media file to reduce processor overhead. The media player 40 is configured to maintain a listing of the checksums, and communicates this information from one node to another so that loading of copies of the same media file 42 is ensured.

In the above example, the complete versions of the media file 42 were made available to the first node 98 and the second node 100 as the first copy of the media file 42a and the second copy of the media file 42b prior to the establishment of the synchronized communication session. The files were previously uploaded to the storage server 16 by one of the members of either one of the first and second nodes 98, 100, and downloaded by the other. This ensures a high quality media review experience despite slow connections to the Internet 14, and frees up bandwidth for other applications, such as real-time video conferencing. It is also contemplated that the media file 42 may be uploaded from the first node 98 to the storage server 16, and streamed as the media file 42 is played back on the second node 100. It is further contemplated that a second media file may be uploaded from the first node 98 to the storage server 16, and automatically downloaded to the second node 100 while streaming the first media file 42 as discussed above. Additionally, peer-to-peer streaming of the media file 42 is also contemplated.

With reference back to FIG. 7, per step 310, a communication session is established between the first node 98 and the second node 100 with a first protocol specific to the media player 40, and more particularly, between the first instance of the media player 40a and the second instance of the media player 40b. The data contained within the first protocol may be transported from the first node 98 to the second node 100 via any of the well known data transport methods in the art. In one embodiment, an underlying connection may be established through the SKYPE Voice-Over-IP (VOIP) network, wherein packet switching, routing and other low level networking functions are abstracted out of the first protocol. In this regard, messages transmitted by the media player 40a according to the first protocol are first transmitted to a local SKYPE provider. As will be appreciated by one of ordinary skill in the art, this ensures a certain Quality of Service (QOS) level for transporting data within a specified time threshold, and enables the establishment of the communication session despite the existence of firewalls utilizing Network Address Translation (NAT), tunneling and the like. Such firewalled networks often preclude the use of applications which require direct client to client connections as would be the case with one embodiment of the present invention. Other network infrastructures may be readily substituted without departing from the scope of the present invention. However, some basic facilities would be preferable according to one embodiment. Some of these features include the ability to identify users by a unique identifier such as by nickname, e-mail address, etc., and to display details relating to such users when online. Additionally, other features include the ability to create a chat room or a conference such that each of the individual users may send and receive typed messages.

According to the first protocol, the following are the messages that may be exchanged in order to establish the communication session:

iM_CALLJOIN—sent from the first node 98 to the second node 100, invites the second node 100 to join the existing communication session.

iM_CALLACCEPT—sent from the second node 100 to the first node 98, accepts the invitation sent by the first node 98 and joins the existing communication session.

iM_CALLREJECT—sent from the second node 100 to the first node 98, rejects the invitation sent by the first node 98.

iM_CALLHANGUP—sent from the second node 100 to the first node 98, terminates the existing communication session.

iM_CALLCONNECT—connects the first node 98 and the second node 100.

With reference again to FIG. 3, specific features of the GUI of the media player 40 that are particularly relevant to the establishment of the communication session will be introduced. A call participant panel 102 lists all of the members participating in the communication session. When no communication session is active, the call participants panel 102 lists only the currently logged in member. According to one embodiment, members participating in the communication session are derived from those online via the SKYPE network, and the nicknames of those members as specified by the unique identifier in SKYPE are displayed in the call participant panel 102. A call button 104 on the call participant panel 102 is operative to initiate the establishment of the communication session, and according to one embodiment, lists all of the SKYPE users that are utilizing the media player 40. The nickname of the SKYPE user is then added to the call participant panel 102. A call hang up button 106 also on the call participant panel 102 is operative to terminate the communication session with a particular member. An information button 108 retrieves a selected user's profile as specified in SKYPE. As utilized herein, the term “user” refers to the individuals as represented by the SKYPE network. Further, the term “member” refers to such SKYPE users that are also connected to each other in the communication session established among the respective media players 40.

After establishing the communication session, the first node 98 becomes synchronized to the second node 100. The term “synchronized communication session” will be used to differentiate from the pre-synchronization state, which will be referred to merely as a “communication session.” During the period of synchronization the first node 98 and the second node 100 are in a state to accept messages from the other containing media review commands. Periodically, messages are exchanged to re-synchronize the location of the play head 58 between the first node 98 and the second node 100. Further details as to the synchronization will be discussed below. Once synchronized, this status is indicated by a status icon 110 that displays “synchronized.” The nodes that are synchronized will be referred to as “participants,” as opposed to “members” that are merely connected to each other in the communication session, i.e., the SKYPE connection. The first node 98 may be de-synchronized by clicking on the status icon 110, which is operative to transmit the “iM_CALL_HANGUP” message to the second node 100. Upon disconnect, the status icon 110 will display “Not Synchronized.” While particular reference has been made to the first and second nodes 98, 100, it will be understood by those having ordinary skill in the art that any number of nodes may connect in the communication session, whether in the synchronized state or not.

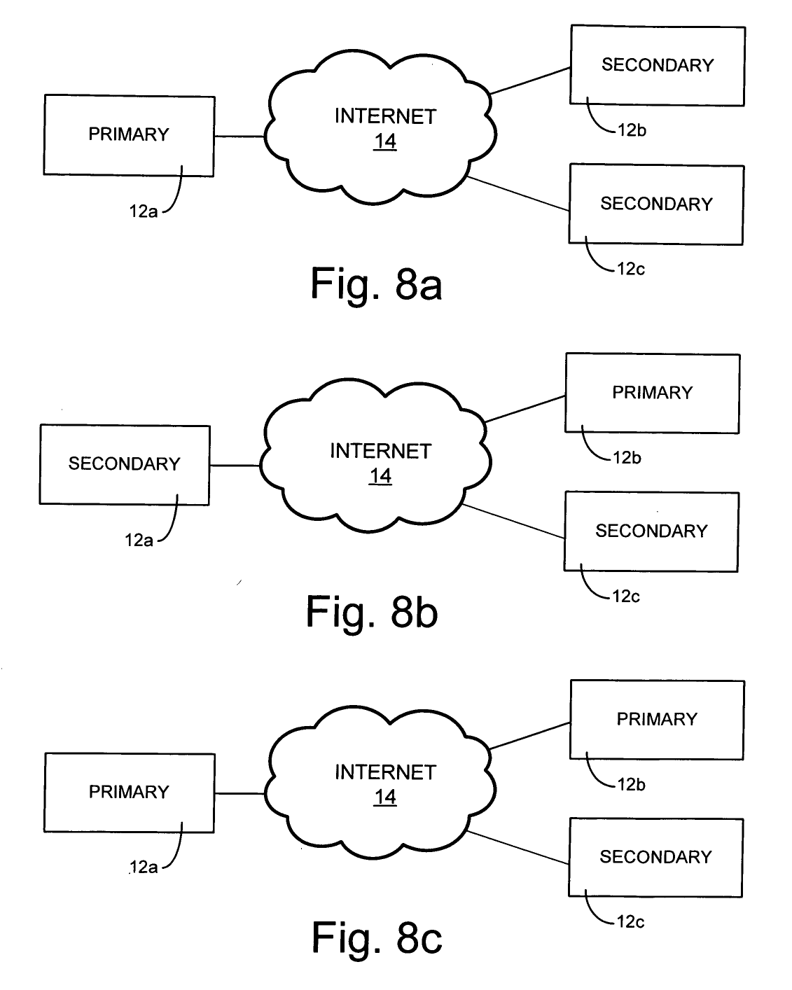

According to another embodiment, one node may be designated a “primary” node capable of issuing media review commands that will be executed on “secondary” nodes. By way of example only and not of limitation, in FIG. 8a, the editor computer system 12a is designated as the primary node, while the producer computer system 12b and the director computer system 12c are designated as the secondary nodes. It is understood that these designations were the result of the editor computer system 12a initiating a synchronized communication session with the producer computer system 12b and the director computer system 12c, as the nodes that initiate the synchronized communication session become primary by default. Any nodes connecting thereafter become secondary by default. As a primary node, any media review commands issued from the user are executed on the primary node, and subsequently re-executed on the secondary nodes as remote media review commands. Secondary nodes disable any input of media review commands, and cannot transmit back media review commands to the primary nodes for execution thereon. More detail relating to the transmission of media review commands will be discussed below.

The synchronized communication session operates on the basis of broadcast messages, meaning that a given message initiating from one node is transmitted to all of the other nodes, and the recipient of the message is responsible for the processing and handling thereof. Accordingly, it is possible for multiple nodes to participate in the synchronized communication session. In order for the editor computer system 12a to relinquish primary status to the producer computer system 12b, the editor computer 12a must transmit a message in the form of “iM_CONFMASTER{userhandle} to both the producer computer system 12b and the director computer system 12c. The “userhandle” parameter is that of the user of the producer computer system 12b. The producer computer system 12b and the director computer system 12c have been informed that the producer computer system 12b is the primary node, and the editor computer system 12c is now set to disable any inputs and enable all messages transmitted only from the producer computer system 12b. Once the aforementioned messages are received and processed, the status is that as illustrated in FIG. 8b.

It is understood that more than one primary node can exist at any given point in time, as illustrated in FIG. 8c. In this case, the editor computer system 12a and the producer computer system 12b are both primary nodes, and came to be by one of the nodes transmitting a message “iM_CONFMASTER” with both the user of the editor computer system 12a and the user of the producer computer system 12b as values for the parameter “userhandle.” As before, the secondary node, i.e. the director computer system 12c, is inoperative to receive any media review commands locally, and is at the direction of the primary nodes. In this regard, priority is given to the primary node that initiates a media review command first.

Referring back to FIG. 3, as an indicator of the primary and secondary status of all of the nodes, the call participants panel 102 includes the control status icons 112a, 112band 112c. The control status icon 112a is accentuated from the others to indicate that the particular computer system 12 of the participant associated therewith is a primary node. Additionally, the control status indicator 114 likewise shows the nickname associated with the primary node. The control status icons 112b and 112c are plain to indicate that the computer systems of the participants associated with such icons 112b and 112c are secondary nodes. The control status indicator 114 may also display “Master” or “not connected” depending on the status of the computer system 12 with which it is associated.

Referring back to FIG. 7, the present invention includes a step 320, in which a local media review command is executed, which will typically also involve receiving a media review command from the media player 42a from a user according to the means discussed above, and performing the instructions thereof. Next, per step 330, a remote media review command is transmitted, which is derived from the local media review command. The remote media review command is then processed by the second instance of the media player 40b, and executed. Referring now to FIG. 6, the media review command input to the first instance of the media player 42a is mirrored on the second instance of the media player 42b. For example, if a user inputs a “play” command to begin playback of the first copy of the media file 42a on the first instance of the media player 40a, playback on the first node 98 begins, and with the commands transmitted to the second instance of the media player 40b, playback also begins on the second node 100. It will be appreciated that the media review command input to the first instance of the media player 42a can be mirrored to any number of additional instances of the media player 42.

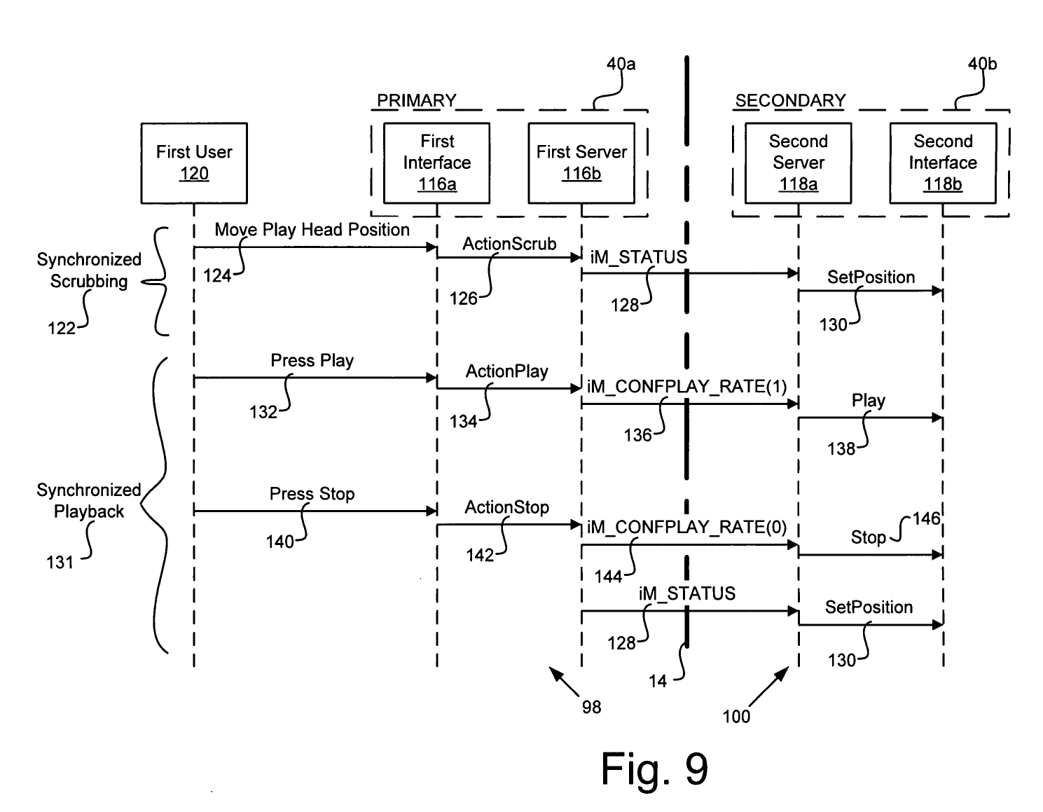

As discussed above, the media review commands include playback commands such as play, stop, fast forward, and rewind, as well as scrubbing. For the purpose of the following discussion, commands which may be issued via a single click of a button will be differentiated from the scrubbing commands, even though all are generally referred to as playback commands. Referring now to FIGS. 9 and 6, further details relating to the synchronization of these commands from one node to another, which is essentially the synchronization of media review on the nodes, will be considered. The sequence diagram of FIG. 9 is segregated by the center line representative of the Internet 14 into the first node 98 on the left hand side and the second node 100 on the right hand side. As depicted in FIG. 6, the first node 98 is the primary node, and the second node 100 is the secondary node. The first node 98 includes the first instance of the media player 40a, and the second node 100 includes the second instance of the media player 40b. As illustrated, the first instance of the media player 40a includes a first interface block 116a and a first server block 116b, and the second instance of the media player 40b likewise fashion includes a second interface block 118a and a second server block 118b.

A user 120 may activate a scrubbing command 122 by providing an input to the first interface block 116a which results in the play head 58 being moved, per action 124. The action 124 is performed locally, on the first node 98 as indicated by the ActionScrub inter-block message 126. The first server block 116b receives this message, and generates an iM_STATUS remote media review command 128, and transmits the same to the second server block 118b of the second node 100. Upon receiving this command, the second server block 118b translates it to a SetPosition inter-block message 130, which is operative to move the position of the play head 58 on the second instance of the media player 40b by the same amount as adjusted in the first instance of the media player 40a. It is noted that the iM_STATUS remote media review command 128 may be transmitted concurrently to any number of other nodes, and processing on such other nodes will proceed similarly to the processing as relating to the second node 100.

The user 120 may also activate a playback command 131 by providing a Play input 132 to the first interface block 116a. An ActionPlay inter-block message 134 is sent from the first interface block 116a to the first server block 116b and concurrently initiates the playing back of the media file 42a. This is essentially issuing a local media review command. The first server block 116b derives an iM_CONF_PLAY_RATE(1) message from the ActionPlay interblock message 134, and is transmitted to the second server block 118b. Once received, the second server block 118b issues a Play inter-block message 138, and the media file 42b loaded on the second node 100 begins to play back. As is understood, the message iM_CONF_PLAY₁₃ RATE is operative to set the play rate and the current time, and the parameter enclosed within the parenthesis indicates which “state,” e.g., playing back or stopped, to transition to. By way of example only and not of limitation, the value “1” indicates that the chosen state is playing back. Similarly, upon the user 120 providing a Stop input 140 to the first interface block 116a, an ActionStop inter-block message 142 is transmitted, with the first server block 116b transmitting an iM_CONF_PLAY₁₃ RATE(0) message to the second server block 118b. As will be apparent, this is the same basic message as that transmitted to initiate the play back of the media file 42b on the second node 100, except for the parameter. This is operative to transmit a Stop inter-block message 146 from the second server block 118b to the second interface block 118a, thereby stopping the playing back of the media file 42b. Upon transitioning to the stop state, the location of the play head 58 is re-synchronized by the first server block 116b transmitting the iM_STATUS message to the second server block 118b. Thereafter, the SetPosition inter-block message 130 is transmitted to the second interface block 118a, operating in the same manner as discussed in relation to the scrubbing command 122. Periodic transmission of the iM_STATUS message in the aforementioned manner keeps the first node 98 and the second node 100 in a synchronized state. These features discussed with particular reference to the second node 100 will be equally applicable to any additional nodes in the synchronized communication session.

It is contemplated that participants of the synchronized communication session are able to share metadata associated with the media file 42 during review. Metadata can be added during the synchronized communication session, or before at the participants' convenience. In one embodiment, the corresponding tag 70 associated with each of the locators 80 are stored in a separate file or database, as described previously. In this embodiment, the separate file or database is propagated to the other participants, and are loaded on the media player 40 of each of the participants.

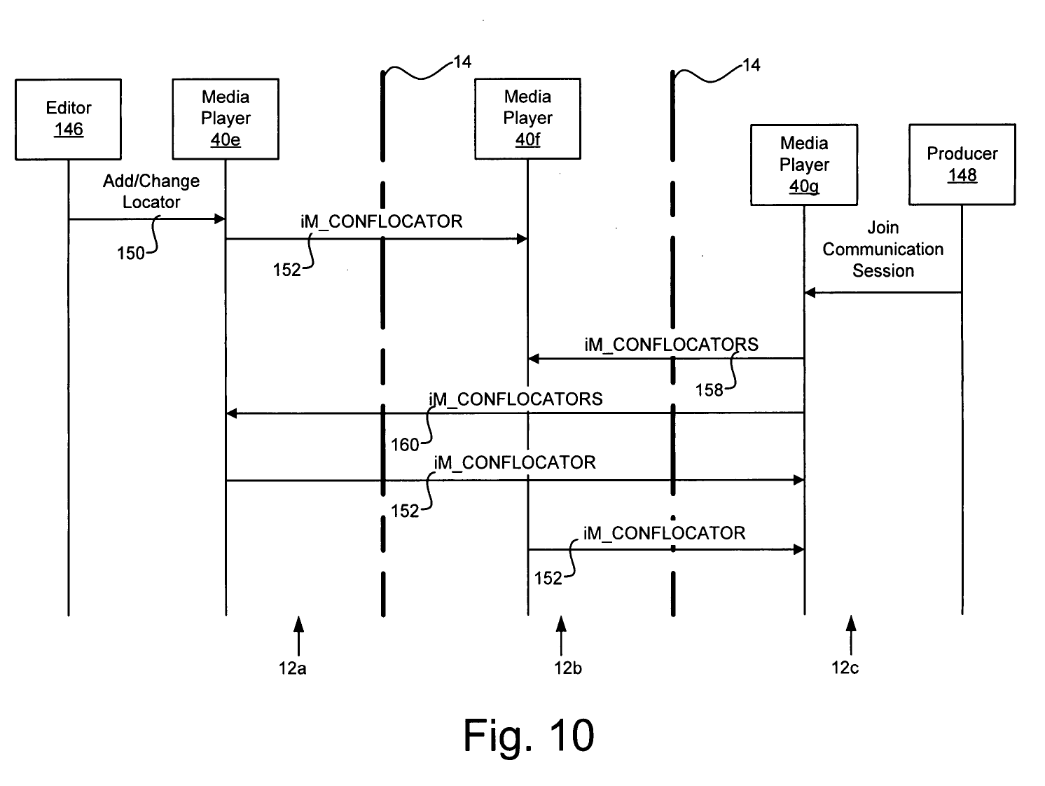

With reference now to FIG. 10, further details of the propagation of the locators 80, a particular type of metadata, will be discussed. For sake of simplicity, the tag 70 of the particular one of the locators 80 representing it will be referred to as the locator 80. On the left side of the diagram is depicted the editor computer system 12a being operated by an editor 146. On the right side of the diagram is the producer computer system 12c operated by a producer 148, and at the center is the director computer system 12b. For purposes of this example, a director has no input involvement so is not depicted. The various computer systems 12 are separated by the Internet 14.

In the first example, the only two computer systems 12 in the synchronized communication session are the editor computer system 12a and the director computer system 12b. Upon the editor 146 adding or changing a locator per sequence 150, an editor media player 40e transmits an iM_CONFLOCATOR message 152 to a director media player 40f. An update 154 of the GUI of the director media player 40f is operative to process the locator 80 as specified in the iM_CONFLOCATOR message 152. If additional computer systems 12 are in the synchronized communication session, the iM_CONFLOCATOR message 152 will be transmitted to there as well.

The iM_CONFLOCATOR message 152 is a serialized object which contains information about a particular one of the locators 80 and an action to perform. One segment “VER” of the object may contain a protocol version, and another segment “ASSET_ID” may contain the checksum value of the particular media file 42 with which the one of the locators 80 is affiliated. Further, another segment “POS” may contain the frame number or time count number with which the one of the locators 80 is associated. Additionally, a “TITLE” segment and a “NOTE” segment may be provided for containing textual data related to the one of the locators 80. The action may be to add, change, or remove the locator contained in the iM_CONFLOCATOR message 152.

The next example illustrates the propagation of the locators 80 upon the producer computer system 12c joining the synchronized communication session as per sequence 156. Thereafter, a producer media player 40g transmits a first and second iM_CONFLOCATORS message 158, 160, respectively, to both the director media player 40f and the editor media player 42. The first and second iM_CONFLOCATORS message 158, 160 is operative to request the locators 80 for the specified media file that the receiving media players, i.e., the director media player 40f and the editor media player 40e are aware of. In response, such known locators 80 are transmitted back to the producer media player 40g through the aforementioned iM_CONFLOCATOR message 152 and imported into the computer producer computer system 12c.

While reference has been made to particular professionals in the entertainment industry such as the editor 146, the producer 148, and the director, it will be appreciated by one of ordinary skill in the art that the present invention need not be limited for use by such individuals in the entertainment field. For example, it may be possible, using the above described features, to synchronize a “virtual tour” with a media file containing a movie of a real estate walk-through between an agent in one location and a buyer in another location. Thus, the agent may direct the buyer's attention to particular segments of the walk-through, all the while commenting thereon. Additionally, it may be possible for two individuals in disparate geographic locations, possibly whom are romantically involved, to share a common “movie night” date experience with each other as provided by appropriate content distributors. Delivery of on-line adult movies may also be enhanced by offering customers similar shared movie viewing experiences combined with videoconferencing. Although specific exemplary uses have been described, it is understood that such examples are not intended to be limiting.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A method of synchronizing media review on first and second nodes, the method comprising the steps of:
loading a primary media file having a plurality of sequenced data segments into the first and second nodes, the media review being related to processing of the data segments of the primary media file for output;
establishing a synchronized communication session between the first node and the second node with a first protocol;
executing a local media review command on the first node, the local media review command including instructions operative to regulate the media review on the first node; and
transmitting from the first node to the second node a remote media review command derived from the local media review command, the remote media review command including instructions operative to regulate the media review of the primary media file on the second node.

2. The method of claim 1, further comprising the step of:
selectively enabling execution of the instructions of the local media review command on the first node, in response to identification of the first node as a primary node.

3. The method of claim 1, further comprising the step of:
selectively disabling execution of the instructions of the remote media review command on the second node, in response to identification of the first node as a secondary node.

4. The method of claim 3, wherein the identification of the first node as the secondary node includes the step of transmitting a primary status relinquishment command from the first node to the second node.

5. The method of claim 1, wherein after establishing the synchronized communication session, the method further includes the step of streaming a secondary media file from the storage server to the second node.

6. The method of claim 1, wherein the step of establishing the synchronized communication session further comprises the step of:
transmitting a session synchronization signal from the first node to the second node, the session synchronization signal including a sequence value specifying the respective one of the data segments of the media file on the first and second nodes, and being operative to initiate the media review of the media file from the data segment specified by the sequence.

7. The method of claim 1, wherein the step of establishing the synchronized communication session is initiated through a teleconferencing protocol different from the first protocol.

8. The method of claim 1, wherein at least one of the data segments of the primary media file includes a reserved area for storing an annotation.

9. The method of claim 1, wherein at least one of the data segments include a pointer referencing an annotation, and an identifier for random access to the one of the data segments.

10. The method of claim 9, wherein the annotation includes text data.

11. The method of claim 9, wherein the annotation includes graphical data.

12. The method of claim 9, further comprising the step of:
exporting to a record the annotation referenced by the pointer associated with the respective one of the data segments of the primary media file, the record including the identifier.

13. The method of claim 9, wherein the identifier is a time code value associated with the one of the data segments of the primary media file.

14. The method of claim 9, wherein the identifier is a frame count value of the one of the data segments of the primary media file.

15. A method of using a computer application on a local node for synchronized media review of a media file with a remote node, the method comprising the steps of:
specifying a location of the media file to load the media file on the local node;
initiating a connection to the remote node, the local node being identified as a primary node,
inputting a media review command, the media review command being operative to regulate the media review on the local node and to transmit a remote media review command to the remote node.

16. The method of claim 15, further comprising the step of:
inputting a primary status relinquishment command, the primary status relinquishment command being operative to identify the local node as a secondary node and to disable input of the media review command on the local node;

17. The method of claim 15, wherein the remote node is loaded with the media file.

18. The method of claim 15, wherein specifying the location further includes the steps of:
establishing a connection to a server storing the media file; and
initiating a download of the file from the server to the local node.

19. The method of claim 15, wherein the remote node is partially loaded with the media file, the unloaded portions of the file being streamed concurrently with the transmission of the remote media review command.

20. The method of claim 15 wherein after the step of initiating the connection to the remote node, the media file is streamed from the local node to the remote node.

21. An article of manufacture comprising a program storage medium readable by a data processing apparatus including a memory and an output device, the medium tangibly embodying one or more programs of instructions executable by the data processing apparatus to perform a method of synchronizing media review on first and second nodes, the method comprising the steps of:
loading a primary media file having a plurality of sequenced data segments into the first and second nodes, the media review being related to processing of the data segments of the primary media file for output;
establishing a synchronized communication session between the first node and the second node with a first protocol;
executing a local media review command on the first node, the local media review command including instructions operative to regulate the media review on the first node; and
transmitting from the first node to the second node a remote media review command derived from the local media review command, the remote media review command including instructions operative to regulate the media review of the primary media file on the second node.

22. The article of manufacture of claim 21, the method further comprising the step of:
selectively enabling execution of the instructions of the local media review command on the first node, in response to identification of the first node as a primary node.

23. The article of manufacture of claim 21, the method further comprising the step of:
selectively disabling execution of the instructions of the remote media review command on the second node, in response to identification of the first node as a secondary node.
